(19) United States
(12) Patent Application Publication
(10) Pub. No.: US 2010/0082809 A1
(43) Pub. Date: Apr. 1, 2010

(54) Network system, information processing device, information processing method, and recording medium

(75) Inventor: Kazuhiro Nakamura, Nagoya-shi (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, NAGOYA-SHI (JP)

(21) Appl. No.: 12/585,656

(22) Filed: Sep. 21, 2009

(30) Foreign Application Priority Data
Sep. 30, 2008 (JP) 2008-255496

(51) Int. Cl. G06F 15/16

(52) U.S. Cl. 709/224

(57) ABSTRACT

A network system is provided in which a plurality of information processing devices are mutually connected through a network.

A monitored device included in a plurality of the information processing devices comprises: a selecting device configured to select a preset number of identification information pieces; a monitored device sending device configured to send a monitor request message; and a response message sending device configured to send a response message indicative of the operating state.

An information processing device which is a final destination of the respective sent monitor request messages is a monitoring device, which comprises: a reception device configured to receive the monitor request message; a monitor message sending device configured to send the monitored device the monitor messages; and a judgment device configured to judge that abnormality has occurred in the operating state.

The entire disclosures of Japanese Patent Application No. 2008-255496 filed on Sep. 30, 2008 including the specification, claims, drawings and abstract is incorporated herein by reference in its entirety.

### BACKGROUND OF THE INVENTION

1. Field of the Invention

The present invention belongs to the field of a network system, an information processing device, an information processing method, and a recording medium. It particularly belongs to the field of a network system where plural information processing devices are connected through a so-called P2P (Peer-to-Peer) network, an information processing device that is included in the network system, and the like.

2. Discussion of Related Art

Recently, a content delivery service such as VOD (video on demand) and internet television has been prevailed due to prevalence of a so-called broadband line.

Attention is focused on networks of a tree type and a grid type that uses the above-described P2P network as a new mode alternative to a server client method that is a mainstream of delivery mode in a current content delivery service. In the P2P network, all terminal devices that participate in the network and receive data delivery are connected through a network, for example, internet. Here, specifically, these terminal devices are realized by a set top box, a personal computer, and the like that are connected to the above-mentioned network installed every home. Hereinafter, the terminal device is simply referred to as “node”.

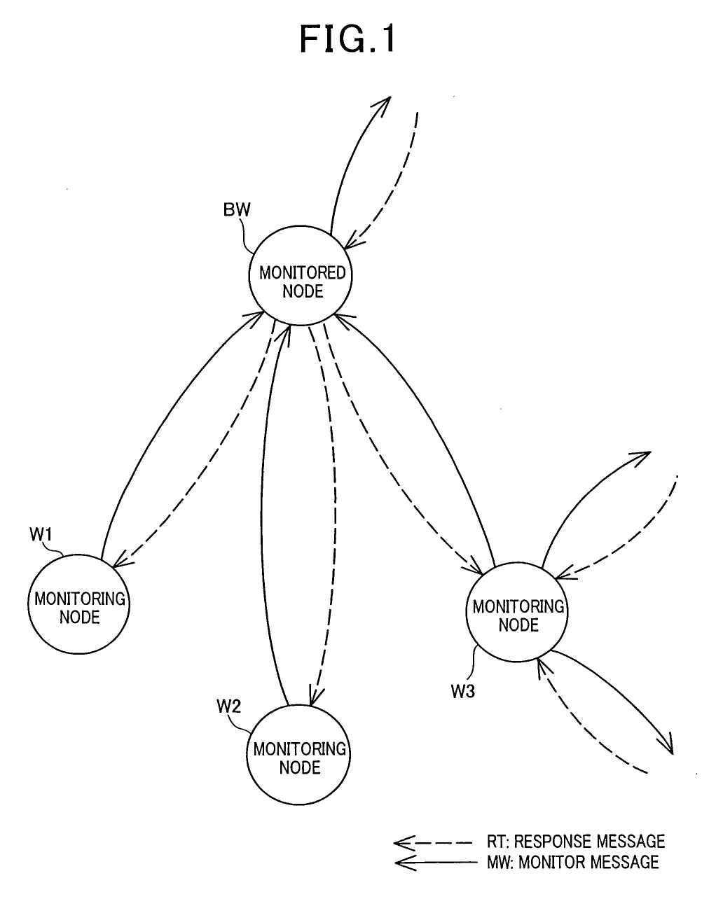

In the P2P network, all or part of a processing unit and a memory unit installed in the respective nodes are provided in an entire network, and all the nodes share all loads that are generated by storing, searching, and, sending and receiving content data subject to be delivered. Such the configuration enables the P2P network to solve disadvantages of the conventional server client method, that are concentration of access from respective nodes to a server as a delivery source, expensive administration cost of servers, or the like. Here, as the conventional art related to a grid-type network using the P2P network, for example, Patent Document 1 described below is cited.

[Patent Document 1] Japanese Unexamined Patent Publication No. 2006-197400 (FIGS. 1 to 5 and others)

### SUMMARY OF THE INVENTION

Although the P2P network has the above-mentioned features, it is fully considered that events such as failure of connection to the network and a power-off operation probably occur in these nodes, because the node itself sharing storage of content data as described above is realized by, for example, a set top box. Occurrence of such events may cause a problem of suspending delivery of the content data apportioned to each of the node and respectively stored therein, into the P2P network.

Accordingly, as one of methods to prevent occurrence of such problems, a method that respective operating states are mutually monitored among respective nodes participating in the P2P network is considered. And in a case where, for example, troubles such as failure of connection to the network and a power off occur in any one of the nodes under the mutual monitoring, it is preferable that other nodes monitoring the node having trouble occurrence carries out an operation to complement the trouble.

However, in a mechanism of the above-described mutual monitoring, there is a possibility that a monitoring number per a node (i.e. a number of other nodes whose operating state is monitored by one node) slants by each of the nodes. Such the slant may spoil a concept of load sharing being a feature of the P2P network described above.

Thus, the present invention is provided in consideration of the above points. An object of the present invention is to provide a network system and the like where respective nodes participating in the P2P network are capable of mutually monitoring the nodes with each other while dispersing monitor loads in the nodes, without using, for example, an administration server for the entire P2P network system.

To solve the above problem, according to the first aspect of the present invention, there is provided a network system in which a plurality of information processing devices are mutually connected through a network, and sending and reception of information is carried out,

wherein a monitored device included in a plurality of the information processing devices which constitute the network system, comprising:

a selecting device configured to select a preset number of identification information pieces by using a predetermined selection method by which an identification information piece is evenly selected from a plurality of the identification information pieces for identifying a plurality of the information processing devices;

a monitored device sending device configured to send a monitor request message for requesting to monitor an operating state of the monitored device to an address of the information processing devices respectively designated by the identification information pieces selected by the selecting device; and

a response message sending device configured to send a response message indicative of the operating state to the information processing device which is a sending source of the monitor request message, in the case where a monitor message of monitoring the operation state is sent from the information processing device which has received the monitor request message, and

wherein the information processing device which is a final destination of the respective sent monitor request messages in the network system is a monitoring device for monitoring the monitored device;

the monitoring device, comprising:

a reception device configured to receive the monitor request message sent by the monitored device sending device;

a monitor message sending device configured to send the monitored device the monitor messages for monitoring the operating state at a predetermined timing, based on a content of the monitor request message received by the reception device; and

a judgment device configured to judge that abnormality has occurred in the operating state, in the case where the response message corresponding to the monitor message sent by the monitor message sending device is not sent from the monitored device.

### DESCRIPTION OF THE PREFERRED EMBODIMENTS

Hereinafter, embodiments of the present invention will be described based on figures.

Here, the embodiments described below are embodiments in a case where the present invention is applied to a P2P network system described in the Patent Document 1. In the Patent Document 1, the node related to the present invention is referred to as “node device”.

### (I) Outline Configuration of P2P Network System

First, with reference to FIG. 1, outline configuration of a P2P network system (hereinafter the P2P network system is simply referred to as “delivery system”) according to the embodiment is described. Here, FIG. 1 is a view exemplifying a state of mutual monitoring in the delivery system according to the embodiment.

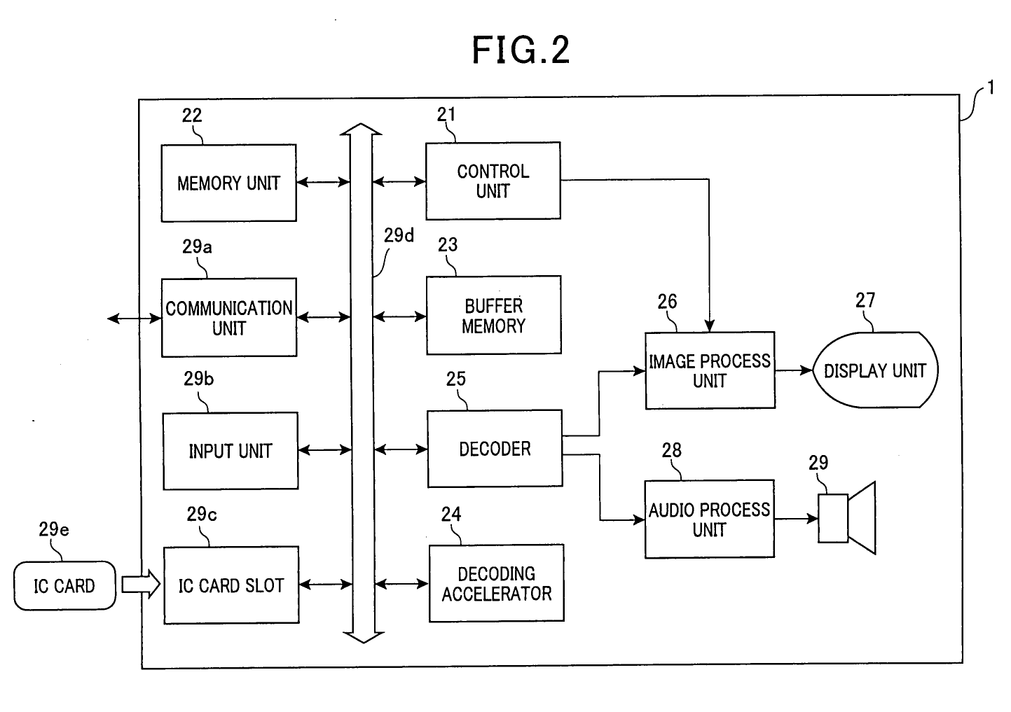

The delivery system according to the embodiment is a delivery system where plural nodes are connected, as exemplified in, for example, FIGS. 1 and 2 and Paragraphs [0037] to [0053] in Patent Document 1.

In this configuration, respective nodes are connected in such manner that they can mutually give and receive data or the like through a physical network, in a manner similar to the node device 1 in the content delivery system described in the above Patent Document 1.

In a case where a new node participates in the delivery system, the node sends a participation request message for the participation to an already participating node being a connection destination at the time of new participation of the node. Here, as a method of selecting the already participating node, it is possible to use, for example, a method of searching a node that is regularly connected to the delivery system (Refer to Paragraph [0046] of Patent Document 1).

On the other hand, in the delivery system, the content to be delivered to respective nodes is input into the delivery system from a so-called content input server. This content input server is a server that is managed by, for example, a manager of the delivery system. Such the content input server inputs content data corresponding to a new content into the delivery system so that the content data can be delivered to respective nodes participating in the delivery system. More specifically, the content input server makes the above-described content data memorized in the content node being a node in the delivery system. Accordingly the content node publicizes the content corresponding to thus memorized content data to the other nodes in the delivery system. More specifically, a publishing method in this case may be referred to, for example, description in Paragraphs [0070] and [0071] of the above Patent Document 1.

Further, respective nodes participating in the delivery system search a desired content in the delivery system, for example, using the so-called “distributed hash table” described in FIGS. 2 to 4 and Paragraphs [0037] to [0061] in the above Patent Document 1, and by a method described in FIG. 5 and Paragraphs [0062] to [0069] in the above Patent Document 1 as well. Then, the content data corresponding to the content discovered as a result of the search are acquired (downloaded) from the content node storing the content data and reproduced.

Next, a configuration of mutual monitoring among plural nodes in a state of operation according to the embodiment is exemplified and described with reference to FIG. 1. Here, FIG. 1 exemplifies a configuration after a monitored node described later selects a monitoring node described later to be charged with monitoring an operating state of the monitored node itself, using the selection method according to the embodiment, and then a monitoring system including thus selected monitoring node an the monitored node is built up.

In the configuration, provided that a certain node is a monitored node, the monitored node is regularly monitored in the operating state by a monitoring node being another node. There exist three such monitoring nodes with respect to a single monitored node in the delivery system according to the embodiment.

In other words, in the delivery system according to the first embodiment as shown in FIG. 1, three units of monitoring nodes W1 to W3 regularly monitor an operating state of a single monitored node BW. In this case, the monitored node BW memorizes identification information (e.g. IP address of respective monitoring nodes W1 to W3) for respectively identifying the monitoring nodes W1 to W3 to monitor it on the delivery system. The respective monitoring nodes W1 to W3 respectively send monitor message MW to the monitored node BW through a network in the preset time respectively. Hereinafter, the monitoring nodes W1 to W3 in block are simply referred to as “monitoring node W”.

The monitored node BW returns a response message RT to respective monitoring nodes W1 to W3 in correspondence with the received monitor message MW. In a case where the monitored node BW is the above-described content node, a list of content IDs of the content memorized at the moment by the monitored node BW being the content node is included in the response message RT.

By the above configuration, the operating state of a single monitored node BM is regularly monitored by three units of monitoring nodes W1 to W3. Accordingly, in a case where there occur troubles such as power-off and connection failure with respect to the network in the monitored node BM, any of the monitoring nodes W1 to W3 detects the trouble promptly and starts a complementary operation for complementing the trouble in thus detected monitoring node W. Here, specifically, as the complementary operation, in a case where for example the monitored node BW is the above-described content node, there is considered a process or the like where the content data memorized therein is replicated to any other node.

Further, the number of monitoring nodes W monitoring the operating state of the single monitored node BW is to be basically determined by correlation between load increment as the entire delivery system that is generated for providing for the above-described monitoring system and reliability of the monitoring system itself.

In other words, the larger the number of the monitoring nodes W to the single monitored nodes BW is, the higher the resistance as the delivery system for the case where plural monitored nodes BW fail at the same time is improved. However, in this case, the load becomes large as an entire delivery system, because receipt amount of the monitor message MW and the like for maintaining the monitoring system necessarily increases on the other hand.

Accordingly, the number of monitoring nodes W to a single monitored node BW is preferable to be selected based on the load increment as the entire delivery system and reliability of the monitoring system itself, for example, a failure rate of the respective nodes 1.

On the other hand, for example, in a case where the above-described troubles such as power-off and connection failure to the network occur in a given monitoring node W1, the above-described monitor message MW is not sent to the monitored node BW in turn. In this case, the monitored node BW itself searches/selects a new monitoring node W in the delivery system by a selecting method according to an embodiment described later, and sends a monitor request message described later to thus selected monitoring node W so as to monitor the monitored node BW. Accordingly a single monitored node BW is kept under monitor of a constant number (three in the case of the embodiment) of monitoring nodes W.

Further, as exemplified in FIG. 1, the monitored node BW itself may also function as a monitoring node with respect to the other node. Further a single monitoring node W (e.g. the monitoring node W3 in the case exemplified in FIG. 1) may take a role of monitoring other plural monitored nodes.

### (II) Embodiment

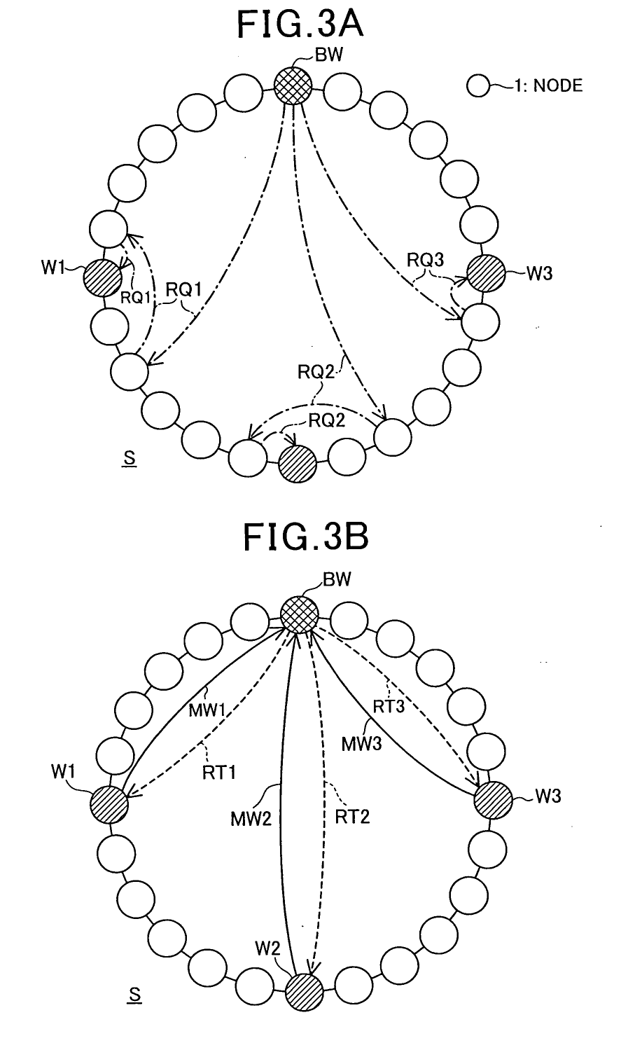

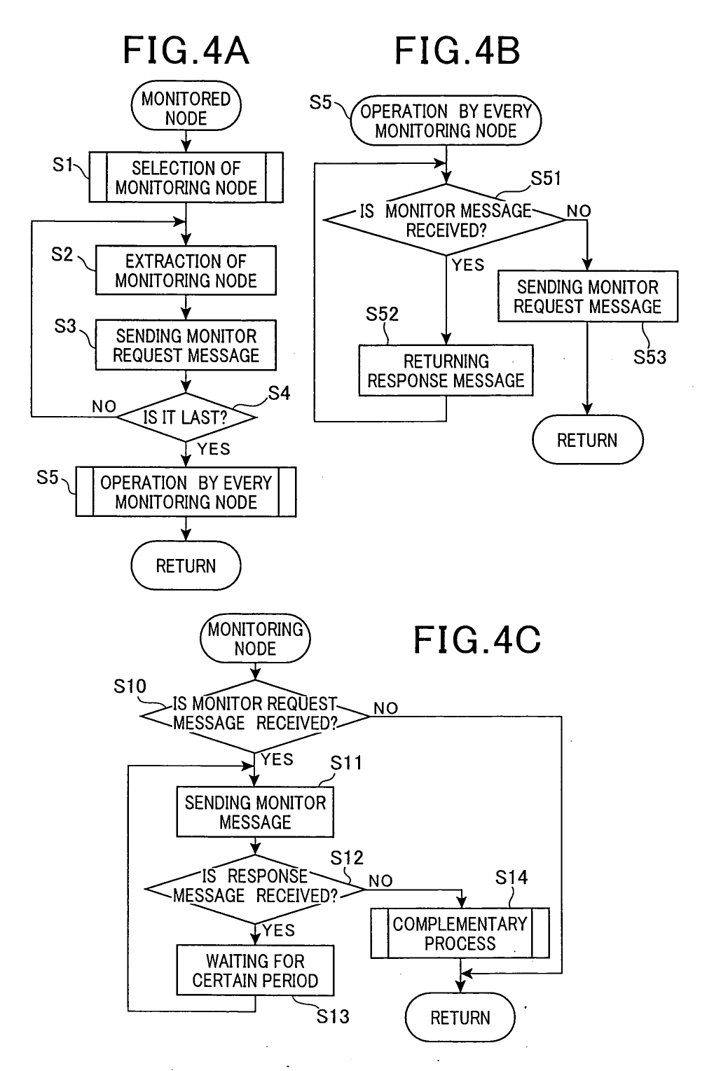

Next, an embodiment according to the present invention will be described using FIGS. 2 to 4. Here, FIG. 2 is a block diagram showing schematic configuration of a node according to the embodiment. FIG. 3 is a view showing an operation of respective monitoring nodes W, a monitored node BW, and the like according to the embodiment. FIG. 4 is a flowchart showing a specific operation in the respective monitoring nodes W, the monitored node, and the like according to the embodiment.

Here, the respective nodes 1 according to the embodiment basically include the same detail configuration and basically carry out the same detail operation independently.

As shown in FIG. 2, the node 1 according to the embodiment is configured by including: a control unit 21 as a selection means, a judgment means, a distance calculation means, a distance comparison means, and a monitoring function setup means; a memory unit 22 as a delivery information memory means; a buffer memory 23; a decoding accelerator 24; a decoder 25; an image process unit 26; a display unit 27; an audio process unit 28; a speaker 29; a communication unit 29a as a monitored device sending means, a response message sending means, a reception means, a transfer means, and a sending means; an input unit 29b; and an IC card slot 29c. These elements are mutually connected through a bus 29d.

Here, the control unit 21 is configured by a CPU having computing function, a RAM for work, and a ROM for memorizing various data and programs (including OS (Operating System) and various applications). The memory unit 22 is configured by an HDD (Hard Disc Drive) and the like for memorizing various data, programs and the like. The buffer memory 23 temporarily accumulates (memorizes) the received content data.

Meanwhile, the decoding accelerator 24 decodes the content data CD thus accumulated in the buffer memory 23 using a decode key. The decoder 25 decodes video data, audio data, and the like included in the decoded content data CD and reproduces (by data stretching or the like). Further, the image process unit 26 carries out a predetermined image process on thus reproduced video data or the like and outputs as an image signal.

On the other hand, the display unit 27 includes CRT (Cathode Ray Tube), liquid crystal display, and the like, and displays a corresponding image in response to the image signal outputted from the image process unit 26. The audio process unit 28 converts thus reproduced audio data into an analog audio signal in use of D/A (digital/analog) conversion, amplifies thus converted signal by an amplifier, and outputs the same. Further, the speaker unit 29 outputs an audio signal outputted from the audio process unit 28 as a sound wave.

Further the communication unit 29a carries out communication control with other nodes 1 in the delivery system through the communication line 9. Further, the input unit 29b includes, for example, a mouse, a keyboard, an operation panel, a remote controller, and the like. The input unit 29b outputs to the control unit 21 an instruction signal in response to various instructions from a user (viewer). The IC card slot 29c reads and writes information with respect to an IC card 29e.

Here, the IC card 29e is tamper resistant and is delivered, for example, from an operator of the delivery system according to the embodiment to a user of respective nodes 1. Here, being tamper resistant means that the IC card is provided with tampering measures so that secret data are protected against read by illegal means and are not easily analyzed. Such the IC card 29e is configured by an IC card controller including CPU, a nonvolatile memory of tamper resistant for example EEPROM (Electrical Erasable and Programmable ROM), and the like. The nonvolatile memory memorizes a user ID, a decode key for decoding encoded content data, a digital certificate, and the like.

On the other hand, the buffer memory 23 is configured by a ring buffer memory of, for example, FIFO (First In First Out) format, and temporarily accumulates content data received through the communication unit 29a in a memory region indicated by a receiving pointer under the control of the control unit 21.

At this time, the control unit 21 integrally controls the entire node 1 by causing CPU therein to read out a program memorized in the memory unit 22 or the like and to carry out the program, and carries out respective operations according to the embodiment described later. In addition, the control unit 21 receives through the communication unit 29a various messages and plural packets (packet constructing content data) that are sent from the other node 1 thorough the network configuring the delivery system by the distributed hash table and writes them in the buffer memory 23, as a normal operation. The control unit 21 reads out various messages and packets that are accumulated (received in the past in a given time) in the buffer memory 23 and further transfers them to the other node 1 through the communication unit 29a based on the distributed hash table.

On the other hand, the buffer memory 23 reads out packets accumulated in the memory region of the buffer memory 23 that is indicated by a reproduction pointer, and outputs them to the decoding accelerator 24 and the decoder 25 through the bus 29d.

Meanwhile, the above-described program may be downloaded from a predetermined server on the network, or may be recorded in a recording medium such as CD-ROM (Compact disc—ROM) and read through a driver of the recording medium.

### (A) Specific Example of Embodiment

Next, a specific example of operation according to the embodiment in the node 1 is exemplified and described using FIG. 3.

The monitored node BW according to the embodiment is regularly subject to the monitor of the three monitoring nodes W in the operating state of the delivery system as exemplified in FIG. 1. In the delivery system according to the embodiment, the monitored node BW subject to the monitor selects by itself the monitoring node W carrying out the monitoring operation in the delivery system.

Specifically, in a case where the monitored node BW according to the embodiment selects the monitoring node W taking charge of monitoring the own operating state when starting the monitor, the monitored node BW uses a distributed hash table that is used for acquiring the above-described content data.

In other words, the monitored node BW obtains a range (e.g. range from “0000” to “ffff” of a node ID) of the node space exemplified in, for example, FIG. 3 of Patent Document 1 based on the distributed hash table (Refer to e.g. FIG. 4 of Patent Document 1) that is memorized in the own memory unit 22 so as not to be volatile. The monitored node BW selects one node 1 every range of respective regions of the node space evenly divided, based on the own node ID of the monitored node BW within a range of this node space. The monitored node BW sends the above-described monitor request message into the delivery system as an address to the node 1 so that the respective nodes 1 thus selected are the monitoring nodes W with respect to these monitored node BW.

More specifically, for example, it is provided that a node ID corresponding to the respective nodes 1 is expressed by four-digit hexadecimal character string in the delivery system of the embodiment. Further, it is provided that the own node ID of the monitored node BW is for example “38a6” and further the above node space is evenly divided by four nodes 1 including the monitored node BW itself (four nodes 1 including the monitored node BW and three monitoring nodes W). In this case, the node IDs of the three nodes 1 except for the monitored node BW (i.e. node ID of the ideal node 1 as the monitoring node W from a view of the monitored node BW) are to be “78a6”, “b8a6”, and “f8a6” respectively.

Accordingly, as exemplified in FIG. 3A, the monitored node BW sends monitor request messages RQ1 to RQ3 to nodes 1 respectively identified by the three node IDs as address.

At this time, the node 1 being an actual final destination of the monitor request messages RQ1 to RQ3 (actually, node 1 being the monitoring node W) is decided only in the course that the monitor request messages RQ1 to RQ3 are transferred in the delivery system based on the distributed hash table. In other words, when next transfer destination is not detected during the transfer in the delivery system, a node 1 being a final destination of the monitor request messages RQ1 to RQ3 actually becomes a monitoring node W.

Further, identification information (e.g. IP address of the monitored node BW) indicative of the monitored node BW is included in the respective monitor request messages RQ1 to RQ3.

Then, as exemplified in FIG. 3A, the respective monitor request messages RQ1 to RQ3 thus sent from the monitored node BW are transferred among the respective nodes 1 respectively based on the above-described distributed hash table that is memorized in the memory unit 22 in the destination node 1 at respective levels, and finally reach the node 1 identified by three node IDs described above.

Then the node 1 receiving any one of the monitor request messages RQ1 to RQ3 during the transfer compares the node ID being a destination of any one of the monitor request messages RQ1 to RQ3 with the own node ID and the other node ID in the ID space, respectively. In a case where there is other node IDs nearer than the own in the ID space with respect to the node ID being the destination, any one of the monitor request messages RQ1 to RQ3 thus received is further transferred based on the distributed hash table. Accordingly, the nodes 1 being the final destinations of the monitor request messages RQ1 to RQ3 respectively function as monitoring nodes W1 to W3 with respect to the monitored node BW sending the monitor request messages RQ1 to RQ3.

In the case as exemplified in FIG. 3A, in the delivery system according to the embodiment, the nodes 1 being destinations of the monitor request messages RQ1 to RQ3 may not actually exist in the delivery system. When a given node 1 receiving for example the monitor request message RQ1 during the transfer judges based on the distributed hash table that there is no next destination of transfer (more specifically, there exists no node ID nearer than the node ID of the given node 1 to the node ID being the destination of the monitor request message RQ1 in the ID space), the node 1 that the monitor request message RQ1 currently reaches functions as the monitoring node W1 with respect to the monitored node BW in response to the monitor request message RQ1.

According to the above configuration, as finally exemplified in FIG. 3B, the monitored node BW starts respectively a transaction of the monitor message MW1 and the response message RT1, with the monitoring node W1; a transaction of the monitor message MW2 and the response message RT2, with the monitoring node W2; and a transaction of the monitor message MW3 and the response message RT3, with the monitoring node W1. Accordingly, the monitoring system of the monitored node BW with three monitoring nodes W (Refer to FIG. 1) goes into operation.

### (B) Operation According to the Embodiment

Next, in order to realize the above-described specific example, specific operation according to the embodiment carried out respectively in the monitoring node W and the monitored node BW is described together using FIG. 4. Here, basically, the respective nodes 1 being the monitoring node W according to the embodiment independently carry out the same operation respectively. Further the operation shown in FIG. 4 is regularly carried out as a part of main routine of a node 1 participating in the delivery system.

Further, in the explanation below, in a case where the monitor request messages RQ1 to RQ3 are referred as generic term, they are simply referred to as “monitor request message RQ”, and the monitor messages MW1 to MW3 are generically referred to as “monitor message MW”.

### (a) Specific Operation in the Monitored Node

First, an operation carried out in a node 1 being the monitored node BW according to the embodiment is described using FIGS. 4A and 4B.

As shown in FIG. 4A, for participating in the delivery system, the control unit 21 in the node 1 being the monitored node BW selects, for example, three nodes 1 as a monitoring node W, which already participated and is committed to monitor the own operating state (Step S1). This selection by the control unit 21 is based on the range of the node ID in the distributed hash table as described in the above item (A). Then, the control unit 21 causes the memory unit 22 of the monitored node BW to memorize a monitoring node list including identification information for identifying thus selected monitoring nodes W (Step S1).

Next, the control unit 21 extracts one monitoring node W from thus selected monitoring node list, for example, at random (Step S2), and sends the above-described monitor request message RQ to thus extracted monitoring node W (Step S3; Refer to FIG. 3A).

Then the control unit 21 confirms whether or not the monitor request message RQ is completely sent to all the monitoring nodes W in the monitoring node list created in the process of Step S1 (Step S4). When there exists the monitoring node W to which the monitor request message RQ is not yet sent (Step S4: NO), the control unit 21 moves to the Step S2 for sending the monitor request message RQ to the monitoring node W.

On the other hand, in the judgment of Step S4, when the monitor request messages RQ are completely sent to all the monitoring nodes W (Step S4: YES), the operation described below is carried out every monitoring node W (Step S5) and the control unit 21 returns to the main routine as the monitored node BW.

Next, the operation of the above Step S5 is described in detail using FIG. 4B.

As an operation of Step S5 carried out every monitoring node W in the monitored node BW, the control unit 21 of the monitored node BW first sends a monitor request message in the operation of the Step S3, and subsequently waits for the monitor message MW from the monitoring node W being the destination, for certain period (Step S51). Then in a case where the monitor message MW is sent from any one of monitoring nodes W (Step S51: YES), the control unit 21 generates a corresponding response message RT and returns it to the monitoring node W retuning the monitor message MW (Step S52; Refer to FIGS. 1 and 3B).

On the other hand, in the judgment of Step S51, when no monitor message MW is sent from the monitoring node W within the predetermined period (Step S51: NO), the control unit 21 judges that some trouble occurs in the monitoring node W. Then the control unit 21 sends the monitor request message RQ again to the node ID being the destination of the monitor request message RQ itself that is supposed to reach the monitoring node W (this node ID being not necessarily the node ID of the monitoring node W that does not receive the monitor message MW) (Step S53). The operations in Steps S51 to S53 described above are carried out every monitoring node W in the control unit 21 of the monitored node BW (Step S5).

### (b) Specific Operation in the Monitoring Node

Next, an operation separately carried out in the nodes 1 being the monitoring nodes W1 to W3 according to the embodiment is described using FIG. 4C.

As shown in FIG. 4C, as a sequence of above-described main routine, the control unit 21 in the node 1 being the monitoring nodes W1 to W3 constantly waits for the monitor request message MW from any node 1 being the monitored node BW (Step S10). When receiving the monitor request message MW (Step S10: YES), the control unit 21 sends the monitor message MW to the monitored node BW in charge of monitoring of the operating state for functioning as the monitoring node W (Step S11; Refer to FIGS. 1 and 3B). Then, the control unit 21 confirms whether or not the response message RT in response to the sent monitor message MW is sent from the monitored node BW (Step S12).

When the response message RT is normally sent (Step S12: YES), the control unit 21 waits for a period preset as a period until the next monitor message MW is sent, and then moves to the operation of the Step S11 for repeating a sequence of the above-described operations.

On the other hand, in the judgment of the Step S12, when the response message RT is not normally sent from the monitored node BW, the control unit 21 of the monitoring node W judges that the above-described trouble occurs in the monitored node BW. The control unit 21 carries out a complementary operation preset for complementing the trouble in the monitored node BW (Step S14). And then the control unit 21 returns to the original main routine for acting as a normal node 1.

Here, as a specific example of the complementary operation in the Step S14, for example the following three examples are considered.

In other words, in a first specific example, it is considered that the monitored node BW having trouble occurrence sends information that the content data is replicated and sent to the monitoring node W carrying out the process, shown in FIG. 4C as a complement request message, to the other node 1 memorizing the content data memorized in the memory unit 22 thereof.

Next, in a second specific example, it is considered that the monitored node BW similarly to the first specific example sends information that a replica of the content data is sent to the other node 1 selected, for example, in terms of random number in the delivery system as a complement request message, to the other node 1 memorizing the content data memorized.

Here, in any case of the first specific example and the second specific example, the respective monitoring nodes W1 to W3 are required to keep track of the other node 1 that memorizes the content data memorized in the memory unit 22 of the monitored node BW monitored by itself.

Finally, in a third specific example, the control unit 21 of the monitoring node W1 first randomly selects the node 1 being a sending destination of the complement request message in the delivery system. It is considered that a request to replicate content data from the other node 1 that memorizes the content data memorized by the monitored node BW and send them to the node 1 is sent to thus selected node 1 as the above-described complement request message.

In this third specific example, not as the first specific example or the second specific example, the monitoring node W is not required to keep track of the other node 1 that memorizes the content data memorized in the memory unit 22 of the monitored node BW that is monitored by the own.

As described above, according to the operation of the monitoring node W and the monitored node BW according to the embodiment, node ID per predetermined number is selected using a predetermined selection method so that the node ID for identifying the node 1 is evenly selected, a monitor request message RQ is sent and addressed to the node 1 of thus selected node ID, and the node 1 being a final destination address of the monitor request message RQ is caused to start monitoring a monitored node BW. Therefore, it is possible to prevent imbalance number of the monitored nodes BW that are assigned by the node 1 taking charge of monitoring.

Accordingly, the number of monitored nodes BW assigned by the node 1 being respective monitoring nodes W is made even as the entire delivery system. Therefore it is possible to disperse load as a monitoring process in the node 1 participating in the delivery system.

Further the node ID is a node ID that is obtained by converting inherent information per node 1 with a distributed hash function and further, the selection method used is a method that a node ID is selected in the order of values of the nodes ID, from a group of node ID other than node ID belonging to the monitored nodes BW, based on the node ID for identifying the monitored node BW itself, with respect to a node space divided so as to include mutually same number of node IDs. Therefore, a single node 1 being monitoring node W is selected every group of node IDs and, as a result, it is possible to make even the number of the monitored nodes BW monitored by the respective monitoring nodes W, as an entire delivery system.

Further, when the monitor message is not sent from the monitoring nodes W, a monitor request message RQ is resent and addressed to the node ID being the destination of the monitor request message RQ that would have reached the monitoring node W. Therefore, in a case where some abnormality may occur in the monitoring node W, it is possible to make a new node 1 a monitoring node W by resending the monitor request message RQ.

Accordingly, even though abnormality occurs in any one of the monitoring nodes W monitoring the monitored node BW, it is possible to maintain the number of the monitoring nodes W monitoring one monitored node BW by making the other node 1 an alternative monitoring node W.

Further, when the node 1 being a transfer destination of the received monitor request message RQ does not exist in the delivery system, the other node 1 having the closest node ID in the ID space becomes the monitoring node W. Therefore, even in a case where the node 1 (i.e. monitoring node W) being a destination of the monitor request message RQ does not exist in the delivery system, the node 1 identified by the other node ID functions as a monitoring node W so that it is possible to secure the number of the monitoring nodes W.

Further, since the monitored node BW is a node 1 having the memory unit 22 for memorizing the content data, it is possible to regularly monitor that abnormality occurs in the monitored node BW for memorizing the content to be delivered in the delivery system, using a monitoring node W.

Therefore, in a case where abnormality occurs in the monitored node BW and content delivery is suspended, it is possible to quickly deal with the delivery suspension.

Here, in a case where the node ID corresponding to the respective nodes 1 is expressed by four-digit hexadecimal character string as in the embodiment, when only the first digit is changed to determine the node 1 being a destination of monitor request message RQ, only fifteen numbers can be selected at maximum. Accordingly, in a case where the number of monitoring nodes W in respect to a single monitored node BW is not to be less than sixteen, the later digit after the second digit of the node ID is required to change together to determine the node 1 being the destination of the monitor request message RQ.

More specifically, it is provided that the node ID of the node 1 being the monitored node BW is for example “38a0” in the hexadecimal character string and the number of the monitoring nodes W is four in respect to one monitored node BW. In this case, it is preferable that the node ID of the node 1 being the destination of the monitor request message RQ for changing only the first digit of the node ID is “68a0”, “98a0” “c8a0”, and “f8a0” according to the present invention where the node ID is evenly dispersed. Meanwhile it is preferable that the node ID of the node 1 being the destination of the monitor request message RQ for changing all digits of the node ID is, for example, “6bd3”, “9f06”, “d239”, and “056c” according to the present invention where the node ID is evenly dispersed.

Further, when the node ID of the node 1 being the destination of the monitor request message RQ is selected, the above-described embodiment uses the method that the region of the ID space related to the distributed hash table is evenly divided with the node ID of the node 1 being a sending source of the monitor request message RQ. Otherwise it may be simply selected in terms of random number. In this configuration, as similar to the embodiment, it is possible to effectively smooth the number of the monitored node BW assigned by the respective monitoring node W the node 1, as an entire delivery system, by selecting the node 1 being the monitoring node W with perfect random number.

Further, programs corresponding to the flowcharts shown in FIG. 4 are recorded in an information recording medium such as a flexible disk or a hard disk or acquired and recorded through the internet, they are read out with a general-purpose computer and executed, and the computer may be activated as the control unit 21 in the node 1 according to the embodiments.

As described above, the present invention is applicable in the field of delivery system for delivering contents, particularly, if it is applied to the field of the P2P-type delivery system, especially remarkable effect can be obtained.

According to the present invention, identification information per predetermined number is selected using a predetermined selecting method so that identification information for identifying an information processing device is evenly selected, a monitor request message is sent and addressed to the information processing device of thus selected identification information, and the information processing device being a final destination address of the monitor request message is caused to start monitoring a monitored device. Therefore, it is possible to prevent imbalance number of monitored devices that are assigned to monitor by the information processing device as the monitoring device.

Accordingly, the number of monitored devices assigned by the information processing devices being respective monitoring devices is made even as the entire network system. Therefore, it is possible to disperse load as a monitoring process in the information processing device participating in the network system.

The present invention is not confined to the configuration listed in the foregoing embodiments, but it is easily understood that the person skilled in the art can modify such configurations into various other modes, within the scope of the present invention described in the claims.

1. A network system in which a plurality of information processing devices are mutually connected through a network, and sending and reception of information is carried out,
wherein a monitored device included in a plurality of the information processing devices which constitute the network system, comprising:
a selecting device configured to select a preset number of identification information pieces by using a predetermined selection method by which an identification information piece is evenly selected from a plurality of the identification information pieces for identifying a plurality of the information processing devices;
a monitored device sending device configured to send a monitor request message for requesting to monitor an operating state of the monitored device to an address of the information processing devices respectively designated by the identification information pieces selected by the selecting device; and
a response message sending device configured to send a response message indicative of the operating state to the information processing device which is a sending source of the monitor request message, in the case where a monitor message of monitoring the operation state is sent from the information processing device which has received the monitor request message, and
wherein the information processing device which is a final destination of the respective sent monitor request messages in the network system is a monitoring device for monitoring the monitored device;
the monitoring device, comprising:
a reception device configured to receive the monitor request message sent by the monitored device sending device;
a monitor message sending device configured to send the monitored device the monitor messages for monitoring the operating state at a predetermined timing, based on a content of the monitor request message received by the reception device; and
a judgment device configured to judge that abnormality has occurred in the operating state, in the case where the response message corresponding to the monitor message sent by the monitor message sending device is not sent from the monitored device.

2. An information processing device, which is the monitored device, included in a network system according to claim 1,
wherein the identification information piece is identification information piece obtained by converting inherent information inherent to every information processing device with a hash function.

3. An information processing device, which is the monitored device, included in a network system according to claim 1,
wherein the selection device uses a selection method of dividing a plurality of the identification information pieces into a plurality of identification information groups, each of which includes the same number of identification information pieces, and selecting a predetermined number of the identification information pieces from an identification information group other than an identification information group to which the monitored device belongs based on the identification information piece for identifying the monitored device itself.

4. An information processing device included in a network system according to claim 1,
wherein the monitored device sending device, in the case where the monitor message is no more sent from the monitoring device, resends the monitor request message to the destination in the monitor request message received by the monitoring device which no more sends the monitor message.

5. An information processing device included in a network system according to claim 1, further comprising:
a second reception device configured to receive the monitor request message sent by the monitored device sending device;
a transfer device configured to transfer the monitor request message received by the second reception device, to the information processing device to which the monitor request message is to be transferred; and
a monitoring function setup device configured to cause the information processing device itself receiving the monitor request message to function as the monitoring device, in the case where the information processing device to which the received monitor request message is to be transferred does not exist in the network system.

6. An information processing device included in a network system according to claim 5, further comprising:
a distance determining device configured to determine a distance among the respective information processing devices in an identification information space; and
a distance comparison device configured to compare the distances determined by the distance determining device;
wherein the transfer device transfers the monitor request message to another information processing device whose distance from the information processing device which is the destination of the monitor request message received by the second reception device is shorter than a distance from the information processing device receiving the monitor request message, as an information processing device to which the received monitor request message is to be transferred.

7. An information processing device, which is the monitored device, included in a network system according to claim 1,
wherein the selection device uses a selection method of randomly selecting the identification information piece.

8. An information processing device included in a network system according to claim 1, further comprising:
a delivery information memory device configured to memorize delivery information delivered to another information processing device through the network.

9. An information processing method in a network system in which a plurality of information processing devices are mutually connected through a network, and sending and reception of information is carried out,
wherein the information processing method comprising steps in a monitored device, and steps in a monitoring device,
the monitored device is included in a plurality of the information processing devices which constitute the network system, and the steps in the monitored device comprises:
selecting a preset number of identification information pieces by using a predetermined selection method by which an identification information piece is evenly selected for a plurality of the information processing devices from a plurality of the identification information pieces for identifying a plurality of the information processing devices;
sending, by the monitored device, a monitor request message for requesting to monitor an operating state of the monitored device to an address of the information processing devices respectively designated by the identification information pieces selected by the selecting step; and
sending, by the monitored device, a response message indicative of the operating state to the information processing device which is a sending source of the monitor request message, in the case where a monitor message of monitoring the operation state is sent from the information processing device which has received the monitor request message, and
wherein the information processing device which is a final destination of the respective monitor request messages sent in the network system is a monitoring device for monitoring a monitored device, and
the steps in the monitoring device comprises:
receiving, by the monitoring device, the monitor request message sent by the monitored device sending step;
sending, by the monitoring device, the monitored device the monitor messages for monitoring the operating state at a predetermined timing, based on a content of the monitor request message received by the reception step; and
judging, by the monitoring device, that abnormality has occurred in the operating state, in the case where the response message corresponding to the monitor message sent by the monitor message sending step is not sent from the monitored device.

10. A computer-readable recording medium in which a program for information processing device is recorded, the program making a computer function as an information processing device according to claim 1.

11. A computer-readable recording medium in which a program is recorded, the program causing a computer provided in a monitored device included in a plurality of information processing devices which constitute a network system in which a plurality of the information processing devices are mutually connected through a network, and sending and reception of information is carried out, to carry out:
selecting a preset number of identification information pieces by using a predetermined selection method by which an identification information piece is evenly selected for a plurality of the information processing devices from a plurality of the identification information pieces for identifying a plurality of the information processing devices;
sending a monitor request message for requesting to monitor an operating state of the monitored device to an address of the information processing devices respectively designated by the identification information pieces selected by the selecting step; and
sending a response message indicative of the operating state to the information processing device which is a sending source of the monitor request message, in the case where a monitor message of monitoring the operation state is sent from the information processing device which has received the monitor request message.

12. A computer-readable recording medium in which a program for information processing device is recorded, the program making a computer function as an information processing device according to claim 2.

13. A computer-readable recording medium in which a program for information processing device is recorded, the program making a computer function as an information processing device according to claim 3.

14. A computer-readable recording medium in which a program for information processing device is recorded, the program making a computer function as an information processing device according to claim 4.

15. A computer-readable recording medium in which a program for information processing device is recorded, the program making a computer function as an information processing device according to claim 5.

16. A computer-readable recording medium in which a program for information processing device is recorded, the program making a computer function as an information processing device according to claim 6.

17. A computer-readable recording medium in which a program for information processing device is recorded, the program making a computer function as an information processing device according to claim 7.

18. A computer-readable recording medium in which a program for information processing device is recorded, the program making a computer function as an information processing device according to claim 8.
